(19) United States
(12) Patent Application Publication
(10) Pub. No.: US 2005/0214395 A1
(43) Pub. Date: Sep. 29, 2005

(54) Spinneret for forming chemical threads and fibres from solutions

(76) Inventors: Vladimir Vladimirovich Rozhdestvenskiy, Glazov (RU); Anatoliy Frantsevich Lositskiy, Glazov (RU); Igor Viktorovich Nozdrin, Glazov (RU); Vladimir Borisovich Philippov, Glazov (RU); Viktor Sergeevich Rodionov, Moscow (RU); Valentin Aleksandrovich Shagaiskiy, Moscow (RU); Anatoliy Leonidovich Beliaev, Glazov (RU); Vladimir Zakharovich Volkov, Tver (RU); Boris Leonidovich Kurushin, Glazov Udmurt (RU)

Correspondence Address: DELLETT AND WALTERS, P. O. BOX 2786, PORTLAND, OR, 97208-2786, US

(21) Appl. No.: 10/515,103

(22) PCT Filed: Mar. 31, 2003
(86) PCT No.: PCT/RU03/00129

§ 371 Date: May 24, 2005

(30) Foreign Application Priority Data
May 18, 2002 (RU) 2002113132

(51) Int. Cl. B28B 5/00

(52) U.S. Cl. 425/72.1

(57) ABSTRACT

A spinneret precluding the possibility for its material to be stuck to a cutting tool in the course of making a calibrated orifice of a small diameter and ideal as to its form, which will contribute to prolonging the service life of such a spinneret, getting a stable method of forming and maintaining good quality of obtained threads and fibers without impairing the corrosion resistance of the spinneret. The objective is achieved owing to the fact that the spinneret is made of a zirconium alloy containing, in wt. %:

| | |
|---|---|
| niobium | 0.05-1.1 |
| oxygen | 0.001-0.2 |
| nitrogen | 0.001-0.006 |
| silicon | 0.001-0.02 |
| iron | 0.001-0.05 |
| molybdenum | 0.001-0.005 |
| impurities | 0.005-0.26 |
| zirconium | the rest. |

The service life of the resultant spinneret may be increased by 8-27%, the stability of the forming method and quality of threads and fibers are increased.

### FIELD OF THE INVENTION

The invention relates to the field of spinnerets for forming chemical threads and fibers from solutions, in particular to spinnerets made of a zirconium-based material.

Known in the art is a spinneret made of a platinum-palladium alloy (75-25) for forming chemical threads and fibers from solutions (TU 3-1744-88: Spinnerets for forming chemical threads and fibers from solutions).

The said spinneret is characterized by a high resistance to corrosion in a process solution for cleaning spinnerets and ensures the required quality of threads and fibers obtained. At the same time the said expensive spinneret has a relatively small service life.

Known in the art is a spinneret made of zirconium for making rayon threads (Metallurgy of Zirconium. Translated from English. Ed. by G. A. Meerson and Yu. V. Gagarinsky. M. IL, 1959, p. 25). It is characterized by a significantly lower cost compared to the above spinneret made of a platinum-palladium alloy (75-25), ensures the required quality of threads obtained. But, the material (zirconium) of the said spinneret has a lower resistance to corrosion in the process solution for cleaning spinnerets, than the said platinum-palladium alloy, a lower resistance to corrosion in the process solution for cleaning spinnerets, which significantly reduces its service life.

The high viscosity of zirconium causes its sticking to a cutting tool in the course of making a spinneret. Especially difficult is the making of a calibrated orifice having a diameter of less than 0.1 mm, which contributes to rising the cost of the method. In a case of a calibrated spinneret of poor quality the possibility of breaking formed threads and fibers in their rewinding, which impairs the consumer properties of the product and makes the method longer.

The closest invention, which has been taken by the inventors as the prototype, is a spinneret for forming chemical threads and fibers from solutions, which is made of a zirconium-based material, i.e., a zirconium alloy containing, in wt. %: niobium—0.05-1.1, oxygen—0.001-0.1, impurities—0.01-0.35, zirconium—the rest (RF Patent No. 2174565, D 01 D 4/02, 2001).

The said spinneret differs from the previously discussed by a significantly lower cost, ensures the required quality of threads obtained, is more corrosion-resistant in the process solution for cleaning spinnerets, and is manufactured easier. But, the said spinneret also, though to a lesser degree, has disadvantages of the zirconium-made spinneret. In the result of insufficiently precise geometry and processing cleanness of the calibrated orifice, which is caused by that the spinneret material sticks to a cutting tool, a percentage of textile thread and fibers not complying with the requirements of GOST 8871-84 as to external defects and breakability of threads (fibers) during their rewinding.

### DESCRIPTION OF THE INVENTION

The objective of the invention is to create a spinneret precluding the possibility for its material to be stuck on a cutting tool in the course of making ideal as to form calibrated orifice contributing to prolonging the service life of such a spinneret, maintaining the stability of a formation method and ensuring required quality of obtained threads and fibers without impairing corrosion resistance of such a spinneret.

The stated objective may be achieved as follows. Unlike the known spinneret for forming chemical threads and fibers from solutions, which is made of a zirconium alloy containing, meanwhile, niobium, oxygen and impurities, according to the claimed invention a zirconium alloy, which a spinneret is made of, additionally contains nitrogen, silicon, iron and molybdenum, the above elements' content of the alloy being, in wt. %:

| | |
|---|---|
| niobium | 0.05-1.1 |
| oxygen | 0.001-0.2 |
| nitrogen | 0.001-0.006 |
| silicon | 0.001-0.02 |
| iron | 0.001-0.05 |
| molybdenum | 0.001-0.005 |
| impurities | 0.005-0.26 |
| zirconium | the rest. |

Making a spinneret of the above many-component zirconium-based alloy results in a significant increase of the spinneret's service life (i.e., period of using a spinneret before replacement), a raise in the stability of a method of forming threads and fibers, improving the quality of threads and fibers (i.e., lowering the quantity of visual defects on threads and reducing the number of breakages while rewinding them) without impairing corrosion resistance of spinnerets in technological solutions for their cleaning. It is associated with the fact that the introduction of additional chemical elements in the stated ranges into the zirconium alloy significantly influences the structure and quality of working the face surface of the spinneret's orifice, which leads to a lesser affinity (stickiness) of a spinning solution (viscose) to the walls of the forming orifice of the claimed spinneret, as compared to the prototype and analogous solutions. This is conditioned by a favorable combination of the electrochemical characteristics of viscose and the claimed spinneret. As a result, a method of forming becomes more stable. The extrusion of viscose through the orifice of the claimed spinneret ensures the obtaining of a more homogenous and less defective stream (filament) and, consequently, threads and fibers of improved quality (having less visual defects and less breakages when they are rewound).

Apart from this, a less affinity (stickiness) of a spinning solution (viscose) to the walls of the forming orifice of the claimed spinneret results in a significant increase of the spinneret's service life (i.e., period of using a spinneret before replacement), as compared to the prototype. This enables to obtain threads and fibers of good quality with a less quantity of spinnerets required for a method of forming. The additional introduction into the zirconium alloy of nitrogen, silicon, iron and molybdenum does not impair the corrosion resistance of the claimed spinneret in a technological solution for its cleaning.

### PREFERRED EMBODIMENT OF THE INVENTION

In order to check the claimed invention comparative stuspinnerets of sample spinnerets made of a platinum-palladium alloy (analogous solution), of zirconium (analogous solution), of a zirconium alloy (the prototype) and the newly created zirconium alloy (the claimed solution) in the laboratory conditions. For tests three new spinnerets have been made of the standard platinum-palladium alloy, having the cap with the diameter 12.5 mm and 50 holes with the diameter 0.08 mm, as well as by three experimental spinnerets of analogous type, made of zirconium (analogous solution), of a zirconium alloy (the prototype) and the newly created zirconium alloy (the claimed solution) with 52 holes each. The length of the cylindrical part in the compared spinnerets has been the same—0.12 mm.

The tests have been conducted on the laboratory spinning unit according to a program simulating the production process of making polyacrylonitrile thread (PAN) of technical purpose. Multiple experiments on each of the spinnerets have been conducted until the spinneret has failed, which has enabled to perform a statistical analysis of the obtained results and assess the probability of differentiating samples for the four compared groups of spinnerets. The plan of the experiment has contained a great number of controlled parameters characterizing both technological processes of obtaining a PAN thread and cleaning the spinnerets in a technological solution, and the physical-mechanical and qualitative parameters of threads, the service life of the spinnerets, etc. At the same time, the corrosion resistance of the sample spinnerets in a technological solution for their cleaning has been assessed according to standard methods. The test results are given in the table.

The analysis of the data given in the table has shown that the claimed technical solution differs from the prototype and the analogous solutions by a longer service life of the spinneret (the relative time of using a spinneret until replacement is: 1.08 to 1.27 for the claimed solution, 1 for the prototype, and 0.58 and 0.64 for the analogous solutions), a higher stability of the process of forming threads and fibers (high for the claimed solution and medium for the prototype and the analogous solutions), a higher quality of the obtained threads and fibers (relative index of visual defects is: 0.82 to 0.97 for the claimed solution, 1 for the prototype, and 1.15 and 1.2 for the analogous solutions), the relative index of breakages quantity of a thread when rewinding is: 0.84 to 0.97 for the claimed solution, 1 for the prototype, and 1.2 and 1.23 for the analogous solutions), without impairing the corrosion resistance of the spinnerets in the technological solution for their cleaning (relative corrosion rate is: 0.72 to 0.9 for the claimed solution, 0.9 for the prototype, and 1 and 1.24 for the analogous solutions). It has been determined that samples of PAN-threads obtained with the use of the spinnerets made of the platinum-palladium alloy (analogous solution), of zirconium (prototype), and of the newly created zirconium alloy (claimed solution) have the similar physical-mechanical characteristics, such as the breaking strength, elongation and modulus.

The optimal composition of the zirconium alloy for a spinneret is the following, in wt. %:

| | |
|---|---|
| niobium | 0.05-1.1 |
| oxygen | 0.001-0.2 |
| nitrogen | 0.001-0.006 |
| silicon | 0.001-0.02 |
| iron | 0.001-0.05 |
| molybdenum | 0.001-0.005 |
| impurities | 0.005-0.26 |
| zirconium | the rest. |

Reducing in the zirconium alloy the content of: nitrogen—less than 0.001 wt. % (experiment No. 4), silicon—less than 0.001 wt. % (experiment No. 9), iron—less than 0.001 wt. % (experiment No. 14), molybdenum—less than 0.001 wt. % (experiment No. 19) and impurities—less than 0.05 wt. % (experiment No. 24) has not resulted in a significant increase in the service life of a spinneret, stability of a method of forming and the quality of threads and fibers, giving, instead, a significant rise in the cost of the alloy.

Increasing in the zirconium alloy the content of: nitrogen—more than 0.006 wt. % (experiment No. 8), silicon—more than 0.02 wt. % (experiment No. 13), iron—more than 0.05 wt. % (experiment No. 18), molybdenum—more than 0.005 wt. % (experiment No. 23) and impurities—more than 0.026 wt. % (experiment No. 28) has resulted in a significant reduction in the corrosion resistance of the zirconium alloy in the technological solution for cleaning spinnerets.

| | | | | | | | | | | | | Quality of PAN | | |
|---|---|---|---|---|---|---|---|---|---|---|---|---|---|---|
| | | | | | | | | | | | | thread | | |
| | | | | | | | | | | | | | Relative | |
| | | | | | | | | | | Relative | | | index of | Relative rate |
| | | | | | | | | | | time of | | | number | of spinneret |
| | | | | | | | | | | work | Stability | Relative | of thread | corrosion in |
| | Variant | Spinneret material, wt. % | | | | | | | | until a | of | index of | breakages | technological |
| | of tech. | zirco- | | | | | | molyb- | impu- | spinneret | forming | visual | when | cleaning |
| No. | solution | nium | niobium | oxygen | nitrogen | silicon | iron | denum | rities | fails | method | defects | rewinding | solution |
| 1 | 2 | 3 | 4 | 5 | 6 | 7 | 8 | 9 | 10 | 11 | 12 | 13 | 14 | 15 |
| 1 | analogous | platinum-palladium alloy | | | | | | | | 0.58 | medium | 1.2 | 1.23 | 1 |
| 2 | analogous | the rest | — | 0.1 | — | — | — | — | 0.03 | 0.64 | medium | 1.15 | 1.2 | 1.24 |
| 3 | prototype | the rest | 1.1 | 0.1 | — | — | — | — | 0.35 | 1 | medium | 1 | 1 | 0.9 |
| 4 | claimed | the rest | 0.5 | 0.05 | 0.0005 | 0.1 | 0.025 | 0.0025 | 0.13 | 1.01 | medium | 1.02 | 1.01 | 0.76 |
| | solution | | | | | | | | | | | | | |
| 5 | claimed | the rest | 0.5 | 0.05 | 0.001 | 0.1 | 0.025 | 0.0025 | 0.13 | 1.1 | high | 0.98 | 0.97 | 0.8 |
| | solution | | | | | | | | | | | | | |
| 6 | claimed | the rest | 0.5 | 0.05 | 0.0035 | 0.1 | 0.025 | 0.0025 | 0.13 | 1.12 | high | 0.95 | 0.93 | 0.85 |
| | solution | | | | | | | | | | | | | |
| 7 | claimed | the rest | 0.5 | 0.05 | 0.006 | 0.1 | 0.025 | 0.0025 | 0.13 | 1.19 | high | 0.83 | 0.86 | 0.9 |
| | solution | | | | | | | | | | | | | |
| 8 | claimed | the rest | 0.5 | 0.05 | 0.007 | 0.1 | 0.025 | 0.0025 | 0.13 | 1.24 | high | 0.80 | 0.82 | 1.0 |
| | solution | | | | | | | | | | | | | |
| 9 | claimed | the rest | 0.5 | 0.05 | 0.0035 | 0.0005 | 0.025 | 0.0025 | 0.13 | 0.98 | medium | 1.05 | 1.02 | 0.78 |
| | solution | | | | | | | | | | | | | |
| 10 | claimed | the rest | 0.5 | 0.05 | 0.0035 | 0.001 | 0.025 | 0.0025 | 0.13 | 1.08 | high | 0.97 | 0.95 | 0.81 |
| | solution | | | | | | | | | | | | | |
| 11 | claimed | the rest | 0.5 | 0.05 | 0.0035 | 0.01 | 0.025 | 0.0025 | 0.13 | 1.12 | high | 0.95 | 0.9 | 0.84 |
| | solution | | | | | | | | | | | | | |
| 12 | claimed | the rest | 0.5 | 0.05 | 0.0035 | 0.02 | 0.025 | 0.0025 | 0.13 | 1.15 | high | 0.82 | 0.87 | 0.89 |
| | solution | | | | | | | | | | | | | |
| 13 | claimed | the rest | 0.5 | 0.05 | 0.0035 | 0.025 | 0.025 | 0.0025 | 0.13 | 1.2 | high | 0.79 | 0.85 | 0.98 |
| | solution | | | | | | | | | | | | | |
| 14 | claimed | the rest | 0.5 | 0.05 | 0.0035 | 0.01 | 0.0005 | 0.0025 | 0.13 | 1.09 | medium | 1.01 | 1.0 | 0.74 |
| | solution | | | | | | | | | | | | | |
| 15 | claimed | the rest | 0.5 | 0.05 | 0.0035 | 0.01 | 0.001 | 0.0025 | 0.13 | 1.10 | high | 0.96 | 0.97 | 0.79 |
| | solution | | | | | | | | | | | | | |
| 16 | claimed | the rest | 0.5 | 0.05 | 0.0035 | 0.01 | 0.025 | 0.0025 | 0.13 | 1.14 | high | 0.9 | 0.95 | 0.82 |
| | solution | | | | | | | | | | | | | |
| 17 | claimed | the rest | 0.5 | 0.05 | 0.0035 | 0.01 | 0.05 | 0.0025 | 0.13 | 1.21 | high | 0.82 | 0.87 | 0.86 |
| | solution | | | | | | | | | | | | | |
| 18 | claimed | the rest | 0.5 | 0.05 | 0.0035 | 0.01 | 0.06 | 0.0025 | 0.13 | 1.26 | high | 0.81 | 0.83 | 1.03 |
| | solution | | | | | | | | | | | | | |
| 19 | claimed | the rest | 0.5 | 0.05 | 0.0035 | 0.01 | 0.025 | 0.0005 | 0.13 | 0.91 | high | 1.02 | 1.03 | 1.03 |
| | solution | | | | | | | | | | | | | |
| 20 | claimed | the rest | 0.5 | 0.05 | 0.0035 | 0.01 | 0.025 | 0.001 | 0.13 | 1.09 | high | 0.97 | 0.95 | 0.79 |
| | solution | | | | | | | | | | | | | |
| 21 | claimed | the rest | 0.5 | 0.05 | 0.0035 | 0.01 | 0.025 | 0.0025 | 0.13 | 1.12 | high | 0.96 | 0.92 | 0.81 |
| | solution | | | | | | | | | | | | | |
| 22 | claimed | the rest | 0.5 | 0.05 | 0.0035 | 0.01 | 0.025 | 0.005 | 0.13 | 1.18 | high | 0.84 | 0.85 | 0.88 |
| | solution | | | | | | | | | | | | | |
| 23 | claimed | the rest | 0.5 | 0.05 | 0.0035 | 0.01 | 0.025 | 0.006 | 0.13 | 1.23 | high | 0.82 | 0.83 | 1.05 |
| | solution | | | | | | | | | | | | | |
| 24 | claimed | the rest | 0.5 | 0.05 | 0.0035 | 0.01 | 0.025 | 0.0025 | 0.003 | 0.99 | medium | 1.01 | 1.0 | 0.7 |
| | solution | | | | | | | | | | | | | |
| 25 | claimed | the rest | 0.5 | 0.05 | 0.0035 | 0.01 | 0.025 | 0.0025 | 0.005 | 1.09 | high | 0.97 | 0.97 | 0.72 |
| | solution | | | | | | | | | | | | | |
| 26 | claimed | the rest | 0.5 | 0.05 | 0.0035 | 0.01 | 0.025 | 0.0025 | 0.13 | 1.13 | high | 0.92 | 0.9 | 0.78 |
| | solution | | | | | | | | | | | | | |
| 27 | claimed | the rest | 0.5 | 0.05 | 0.0035 | 0.01 | 0.025 | 0.0025 | 0.26 | 1.19 | high | 0.85 | 0.84 | 0.88 |
| | solution | | | | | | | | | | | | | |
| 28 | claimed | the rest | 0.5 | 0.05 | 0.0035 | 0.01 | 0.025 | 0.0025 | 0.27 | 1.25 | high | 0.81 | 0.80 | 1.1 |
| | solution | | | | | | | | | | | | | |
| 29 | claimed | the rest | 0.05 | 0.001 | 0.001 | 0.001 | 0.001 | 0.001 | 0.005 | 1.11 | high | 0.92 | 0.95 | 0.86 |
| | solution | | | | | | | | | | | | | |
| 30 | claimed | the rest | 1.1 | 0.2 | 0.006 | 0.02 | 0.05 | 0.005 | 0.26 | 1.27 | high | 0.84 | 0.87 | 0.89 |
| | solution | | | | | | | | | | | | | |

Note:
The table shows the average values according to the test results for three spinnerets.

### INDUSTRIAL APPLICABILITY

For the purpose of full-scale production tests of the claimed invention a pilot lot of spinnerets of type F41Tsr 12,5 has been made in the quantity of 500 pieces from blanks made at OAO ChMZ. The tests have been conducted at OAO “Klinvolokno” and have fully confirmed the conclusions stated in the description.

The zirconium alloy for the blanks has been made according to the authorized technology applied at OAO ChMZ by melting an ingot from the stock of the following composition:
60%—recycles of Class V (standard blanks from bars of iodide zirconium),
40%—recycles of Class VI after tumbling (forge waste of the zirconium alloy E125).

Earlier, the niobium, oxygen, nitrogen, silicon, iron, molybdenum, impurities content of the recycles has been determined. Then, the recycles have been grouped according to the chemical composition, and the stock composition has been prepared on the basis of preliminary calculations of the necessary quantity of each element in the structure of the future alloy.

The ingot has been melted in vacuum furnaces for arch remelting. A sheet has been rolled out of the obtained ingots according to a standard technology, and then it has been cut into strips. Caps for spinnerets have been made from strips by deep pressing with drawing.

Then, holes in a spinneret have been punched, the spinneret bottom has been polished with the GOI paste, and the working holes in the spinnerets have been manually calibrated to the size.

1. A spinneret for forming chemical threads and fibers from solutions, being made of a zirconium alloy containing zirconium, niobium, oxygen and impurities, characterized in that the said zirconium alloy additionally contains nitrogen, silicon, iron and molybdenum, the above elements' content of the alloy is, in wt. %:

| | |
|---|---|
| niobium | 0.05-1.1 |
| oxygen | 0.001-0.2 |
| nitrogen | 0.001-0.006 |
| silicon | 0.001-0.02 |
| iron | 0.001-0.05 |
| molybdenum | 0.001-0.005 |
| impurities | 0.005-0.26 |
| zirconium | the rest. |
